(19) United States
(12) Patent Application Publication
(10) Pub. No.: US 2026/0045263 A1
(43) Pub. Date: Feb. 12, 2026

(54) ENCODING DEVICE AND ENCODING METHOD

(71) Applicant: Panasonic Intellectual Property Corporation of America, Torrance, CA (US)

(72) Inventors: Yuichi KAMIYA, Ishikawa (JP); Hiroyuki EHARA, Kanagawa (JP)

(73) Assignee: Panasonic Intellectual Property Corporation of America, Torrance, CA (US)

(21) Appl. No.: 19/150,065

(22) PCT Filed: Jan. 19, 2024
(86) PCT No.: PCT/JP2024/001505

§ 371 Date: Jul. 22, 2025

(30) Foreign Application Priority Data
Feb. 8, 2023 (JP) 2023-017778
Apr. 12, 2023 (JP) 2023-064797

(51) Int. Cl. G10L 19/008; G10L 19/02; G10L 19/12; H04S 1/00; H04S 7/00

(52) U.S. Cl. CPC G10L 19/008; G10L 19/02; G10L 19/12; H04S 1/007; H04S 7/30

(57) ABSTRACT

This encoding device comprises: a control unit that, if an inputted stereo signal is determined to be a signal suitable for encoding using a mid-side stereo system, determines whether to apply a first encoding mode or a second encoding mode on the basis of a numerical value calculated by using the number of bits estimated to be necessary for encoding a mid-channel and the number of bits estimated to be necessary for encoding a side channel; a first encoding unit that, if application of the first encoding mode is determined, applies code-excited-linear-prediction (CELP) encoding to a mid-channel signal; and a second encoding unit that, if application of the second encoding mode is determined, performs spectral encoding on a stereo signal.

### TECHNICAL FIELD

The present disclosure relates to an encoding apparatus and an encoding method.

### BACKGROUND ART

A low-bit-rate encoding technique for speech/acoustic signals is known (e.g., see Non-Patent Literature (hereinafter, referred to as NPL) 1).

### CITATION LIST

### Patent Literature

PTL 1
Japanese Patent Application Laid-Open No. 2021-119383
PTL 2
Japanese Unexamined Patent Application Publication (Translation of PCT Application) No. H7-501190
PTL 3
Japanese Unexamined Patent Application Publication (Translation of PCT Application) No. 2011-527445

### Non-Patent Literature

NPL 1
3GPP TS 26.445 V16.2.0, “Codec for Enhanced Voice Services (EVS); Detailed Algorithmic Description (Release 16)”, 2021-12.
NPL 2
Takehiro SUGIMOTO, Kotaro KINOSHITA, “Angular resolution required for reproduction of speech on the arbitrary radiation direction: Examination in the horizontal and median planes,” Proc. Autumn Meet. Acoust. Soc. Jpn., 2-8-8, September 2021

### SUMMARY OF INVENTION

There is room for study on a method for enhancing coding performance for speech/acoustic signals in the low-bit-rate encoding technique.

A non-limiting example of the present disclosure facilitates providing an encoding apparatus and an encoding method each capable of enhancing coding performance for speech/acoustic signals in the low-bit-rate encoding technique.

An encoding apparatus according to an example of the present disclosure includes: a controller, which in operation, determines, in a case where an inputted stereo signal is determined to be a signal suitable for encoding using a mid-side stereo scheme, whether to apply a first coding mode or a second coding mode, based on a numerical value calculated by using a number of bits estimated to be necessary for encoding a mid-channel and a number of bits estimated to be necessary for encoding a side-channel; a first encoder, which in operation, applies Code-Excited-Linear-Prediction (CELP) coding to a signal of the mid-channel in a case where the first coding mode is determined to be applied; and a second encoder, which in operation, performs spectral coding on the stereo signal in a case where the second coding mode is determined to be applied.

It should be noted that general or specific embodiments may be implemented as a system, an apparatus, a method, an integrated circuit, a computer program, a storage medium, or any selective combination thereof.

According to an example of the present disclosure, it is possible to enhance coding performance for speech/acoustic signals in the low-bit-rate encoding technique.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 illustrates an exemplary configuration of an encoding system;

FIG. 2 illustrates an example of a detailed configuration of the encoding system;

FIG. 3 illustrates another example of the detailed configuration of the encoding system;

FIG. 4 is a flowchart illustrating an example of processing of calculating an amplitude adjustment coefficient;

FIG. 5 illustrates an example of encoding processing;

FIG. 6 illustrates an example of coding mode determination processing;

FIG. 7 illustrates another example of the coding mode determination processing;

FIG. 8 is a flowchart illustrating an example of stereo encoding processing;

FIG. 9 is a flowchart illustrating an example of Inter-channel time difference (ITD) adjustment processing;

FIG. 10 illustrates an exemplary pseudo code of the ITD adjustment processing;

FIG. 11 is an exemplary set of Finite Impulse Response (FIR) filter coefficients used in the ITD adjustment processing;

FIG. 12 illustrates an example of transition of switching coding modes in the encoding system;

FIG. 13 illustrates an example of transition of channel conversion in the encoding system;

FIG. 14 illustrates an exemplary configuration of a decoding system;

FIG. 15 illustrates still another example of the detailed configuration of the encoding system; and

FIG. 16 illustrates still another example of the coding mode determination processing.

### DESCRIPTION OF EMBODIMENTS

Hereinafter, an embodiment of the present disclosure will be described in detail with reference to the accompanying drawings.

Patent Literature (hereinafter, referred to as PTL) 1 discloses a high-efficiency Modified Discrete Cosine Transform (MDCT) stereo coding scheme that combines a Mid-Side (M/S) stereo scheme and a Left-Right (LR) stereo scheme. Further, for example, a method for switching between an M/S stereo scheme and an LR stereo scheme in transform coding for stereo signals is known (e.g., see PTLs 1 and 2).

However, the coding performance for speech signals at low bit rates is possibly insufficient in the MDCT coding (or referred to as MDCT-based coding) disclosed in PTL 1.

Further, for example, in PTL 1, a “full Mid-Side coding mode (full M/S coding mode),” in which an M/S stereo scheme is configured in all of a plurality of sub-bands obtained by dividing a spectrum of an inputted stereo signal (e.g., also referred to as frequency bands or spectral bands), can be selected. In PTL 1, an MDCT-based coding scheme is applied when the full Mid-Side coding mode is selected, but depending on the bit rate, Code Excited Linear Prediction (CELP) coding (also referred to as CELP-based coding) possibly achieves better coding performance for speech signals.

Further, for example, while the introduction of CELP coding can improve the coding performance, in coding of speech signals using an M/S stereo scheme, an inter-channel time difference (ITD) easily affects the coding performance. Thus, when the inter-channel time difference (ITD) is not zero in coding of speech signals using the M/S stereo scheme, the coding performance for stereo signals using CELP coding possibly deteriorates or is insufficient.

Then, in an embodiment of the present disclosure, a method for enhancing coding performance for speech signals at low bit rates will be described.

### First Embodiment

### [Exemplary Configuration of Encoding System]

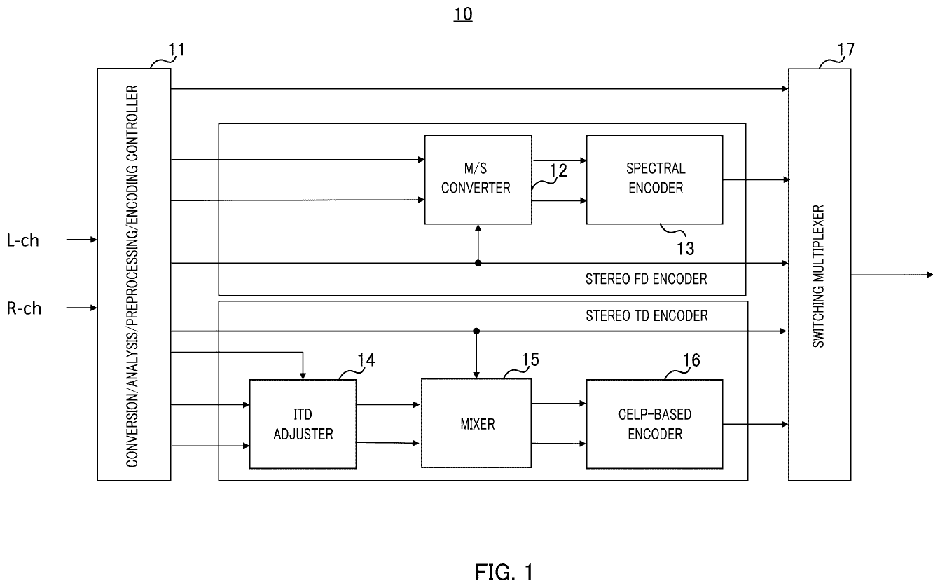

FIG. 1 illustrates an exemplary configuration of encoding apparatus 10 (or referred to as “encoding system”).

Encoding apparatus 10 may include, for example, conversion/analysis/preprocessing/encoding controller 11, M/S converter 12, spectral encoder 13, ITD adjuster 14, mixer 15, CELP-based encoder 16, and switching multiplexer 17.

For example, a stereo signal including a left channel (L-channel) signal and a right channel (R-channel) signal may be inputted to conversion/analysis/preprocessing/encoding controller 11.

Conversion/analysis/preprocessing/encoding controller 11 may, for example, convert the L-channel and R-channel signals into signals in the frequency domain, and may output the L-channel and R-channel signals converted into signals in the frequency domain to M/S converter 12. The conversion processing in conversion/analysis/preprocessing/encoding controller 11 may be processing of converting signals in the time domain into parameters of the frequency domain (spectral parameter), such as Fast Fourier Transform (FFT), Discrete Fourier Transform (DFT), or MDCT.

Further, conversion/analysis/preprocessing/encoding controller 11 may, for example, control M/S conversion in M/S converter 12, and may output information on M/S conversion (e.g., referred to as “M/S conversion control information”) to M/S converter 12. M/S conversion control information may include, for example, information on whether to perform LR-M/S conversion in M/S converter 12, or information on a sub-band on which The M/S conversion control information is also LR-M/S conversion is performed. outputted to switching multiplexer 17.

Further, conversion/analysis/preprocessing/encoding controller 11 may, for example, output the L-channel and R-channel signals in the time domain to ITD adjuster 14. Furthermore, conversion/analysis/preprocessing/encoding controller 11 may perform, for example, control related to ITD adjustment, and output control information on the ITD adjustment (e.g., referred to as “ITD adjustment control information”) to ITD adjuster 14. The ITD adjustment control information may be, for example, information indicating an ITD adjustment value or information for determining an ITD adjustment value in ITD adjuster 14.

In addition, conversion/analysis/preprocessing/encoding controller 11 may, for example, control mixing in mixer 15, and may output control information on the mixing (e.g., referred to as “mixing control information”) to mixer 15. The mixing control information may include, for example, information on a parameter (example will be described later) used for mixing in mixer 15. The mixing control information is also outputted to switching multiplexer 17.

Moreover, conversion/analysis/preprocessing/encoding controller 11 may perform analysis processing of analyzing characteristics of the L-channel and R-channel signals, for example. The analysis processing may, for example, include processing such as Inter-channel Cross Correlation (ICC) analysis, inter-channel time difference (ITD) analysis, Inter-channel Level Difference (ILD) analysis, or pitch analysis. Conversion/analysis/preprocessing/encoding controller 11 may, for example, output information on the analysis result (e.g., referred to as “analysis information”) to ITD adjuster 14 or another component.

In addition, conversion/analysis/preprocessing/encoding controller 11 may perform preprocessing such as pre-emphasis or auditory masking (or perceptual weighting).

Further, conversion/analysis/preprocessing/encoding controller 11 may, for example, perform control of switching coding modes, and may output control information on the switching of coding modes (e.g., referred to as “coding mode information”) to switching multiplexer 17. The coding mode information may include, for example, a coding mode to be applied between encoding of a stereo signal in the frequency domain (e.g., referred to as “stereo Frequency Domain (FD) encoding”) and encoding of a stereo signal in the time domain (e.g., referred to as “stereo Time domain (TD) encoding”). As illustrated in FIG. 1, the stereo FD encoder that performs stereo FD encoding may include M/S converter 12 and spectral encoder 13, and the stereo TD encoder that performs stereo TD encoding may include ITD adjuster 14, mixer 15, and CELP-based encoder 16.

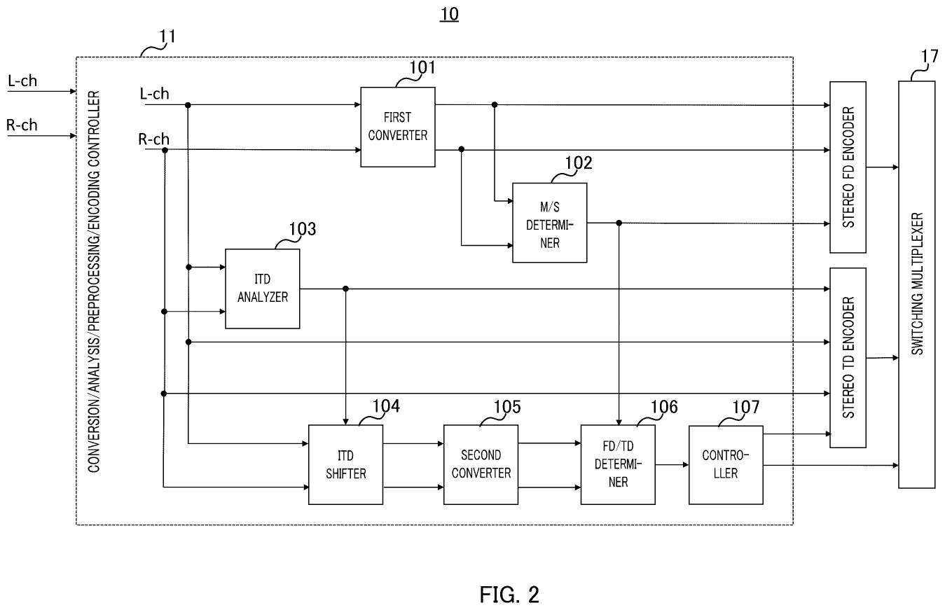

Here, an exemplary internal configuration of conversion/analysis/preprocessing/encoding controller 11 in encoding apparatus 10 in FIG. 1 will be described with reference to FIG. 2. Conversion/analysis/preprocessing/encoding controller 11 may include first converter 101, M/S determiner 102, ITD analyzer 103, ITD shifter 104, second converter 105, FD/TD determiner 106, and controller 107. In FIG. 2, the stereo FD encoder, the stereo TD encoder, and switching multiplexer 17 are in common with FIG. 1.

For example, a stereo signal including a left channel (L-channel) signal and a right channel (R-channel) signal may be inputted to first converter 101. First converter 101 may, for example, convert each of the L-channel signal and the R-channel signal in the time domain into a signal in the frequency domain, and output the L-channel signal and the R-channel signal converted into the frequency domain to the stereo FD encoder and M/S determiner 102. Time-frequency conversion processing in first converter 101 needs only be, for example, processing of converting a signal in the time domain into a parameter (spectral parameter) in the frequency domain, such as FFT, DFT, or MDCT, but is not limited thereto.

For example, a stereo signal in the frequency domain that includes the L-channel signal and the R-channel signal converted into the frequency domain and is outputted from first converter 101 may be inputted to M/S determiner 102. M/S determiner 102 estimates, for example, the number of bits to be necessary when encoding the stereo signal in the frequency domain as an LR stereo signal and the number of bits to be necessary when encoding the stereo signal as an M/S stereo signal, and determines a stereo signal scheme by which encoding is enabled with a smaller number of bits between an M/S stereo scheme and an LR stereo scheme. This determination may be performed for each frequency band, and a case where it is determined that encoding is performed using the M/S stereo scheme for all frequency bands may be referred to as a full M/S coding mode. M/S determiner 102 may output, to the stereo FD encoder and FD/TD determiner 106, information on the determination result indicating which of the M/S stereo scheme and the LR stereo scheme is used. For example, as disclosed in PTL 1, a method described in sections 5.3.3.2.8.1.3 to 5.3.3.2.8.1.7 in NPL 1 may be used for estimating the number of bits.

For example, a stereo signal including an L-channel and an R-channel may be inputted to ITD analyzer 103. ITD analyzer 103 may obtain, for example, an inter-channel time difference (ITD) between channels of the inputted stereo signal. ITD analyzer 103 may output information related to the obtained ITD (ITD information) to the stereo TD encoder and ITD shifter 104.

For example, a stereo signal including an L-channel signal and an R-channel signal may be inputted to ITD shifter 104. In addition, the ITD information outputted from ITD analyzer 103 may be inputted to ITD shifter 104. ITD shifter 104 may perform a time shift on the signal of one of the channels using the ITD information inputted from ITD analyzer 103 so that a time difference between channels of the inputted stereo signal is eliminated. In general, a time shift is performed so that the channel signal having a time delay between the L-channel signal and the R-channel signal in the time domain matches the other channel signal. ITD shifter 104 may output the stereo signal on which the time shift processing has been performed to second converter 105.

For example, second converter 105 may convert the L-channel signal and the R-channel signal after the time shift processing (also referred to as a stereo signal after the time shift processing) into signals in the frequency domain, and output the stereo signal after the time shift processing and converted into the frequency domain to FD/TD determiner 106. The conversion processing in second converter 105 may be the same as or different from the conversion processing in first converter 101.

M/S determination information indicating which of the M/S stereo scheme and the LR stereo scheme is used may be inputted to FD/TD determiner 106 from M/S determiner 102. In addition, the stereo signal after the time shift processing and converted into the frequency domain may be inputted to FD/TD determiner 106 from second converter 105.

For example, in a case where the M/S determination information indicating the full M/S coding mode, in which the M/S stereo scheme is used for all frequency regions, is inputted from M/S determiner 102, when the stereo signal after the time shift processing and converted into the frequency domain is encoded as an M/S stereo signal, FD/TD determiner 106 may estimate the number of bits “Bm” to be necessary for encoding the Mid-channel signal and the number of bits “Bs” to be necessary for encoding the Side-channel signal, and determine whether to perform FD stereo encoding or TD stereo encoding based on a numerical value (e.g., a value of Bm/(Bm+Bs)) calculated using Bm and Bs. Details of this determination will be described below. FD/TD determiner 106 may output, to controller 107, coding mode information indicating whether to select the FD stereo coding mode or the TD stereo coding mode.

For example, the coding mode information indicating which of the FD stereo coding mode or the TD stereo coding mode is selected may be inputted to controller 107 from FD/TD determiner 106. For example, controller 107 determines the mixing control information based on the coding mode information inputted from FD/TD determiner 106, and outputs the mixing control information to the stereo TD encoder. In a case where the inputted coding mode information transitions (switches) from the TD coding mode to the FD coding mode between frames, controller 107 may change the coding mode information from the FD coding mode to the TD coding mode, and output final coding mode information to switching multiplexer 17. In other cases, the inputted coding mode information may be outputted to switching multiplexer 17 as the final coding mode information as it is.

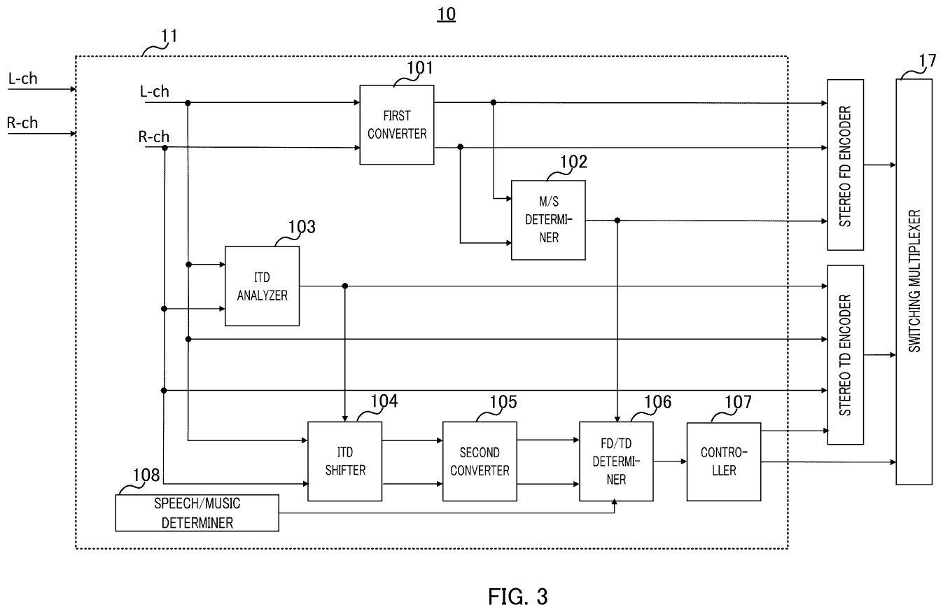

FIG. 3 illustrates another configuration example of encoding apparatus 10 including conversion/analysis/preprocessing/encoding controller 11 further provided with speech/music determiner 108 that determines whether a type of an input stereo signal is a speech signal, with respect to the above-described configuration example of FIG. 2. Since the configurations other than speech/music determiner 108 are in common with those in FIG. 2, the description thereof will be omitted. In FIG. 3, the input to speech/music determiner 108 is not shown, but a stereo signal including a left channel (L-channel) signal and a right channel (R-channel) signal may be inputted, or an analysis result outputted by an analyzer that inputs the stereo signal and performs some analysis may be inputted. In any case, speech/music determiner 108 outputs, to FD/TD determiner 106, information related to whether the stereo signal is a speech signal. FD/TD determiner 106 uses the information inputted from speech/music determiner 108 for determining the coding mode. For the speech/music determination, for example, a method disclosed in PTL 3 or section 5.1.13.6 in NPL 1 can be used. Speech/music determiner 108 may be provided in the stereo TD encoder or the stereo FD encoder, and in this case, past speech/music determination results may be inputted to FD/TD determiner 106.

The example of the internal configuration of conversion/analysis/preprocessing/encoding controller 11 has been described above.

Returning to FIG. 1, in encoding apparatus 10, M/S converter 12 and spectral encoder 13 may constitute a stereo FD encoder (e.g., corresponding to a second encoder) that performs stereo FD encoding. Note that M/S converter 12 in FIG. 1 is not necessary in a case where the result of the M/S conversion is outputted from M/S determiner 102 in FIG. 2. In this case, M/S converter 12 is included in M/S determiner 102, and in the stereo FD encoder, the stereo signal outputted from M/S converter 12 may be inputted to spectral encoder 13 instead of the stereo signal outputted from first converter 101 in FIG. 2.

For example, the L-channel signal and the R-channel signal in the frequency domain (e.g., spectral parameters) and the M/S conversion control information are inputted to M/S converter 12 from conversion/analysis/preprocessing/encoding controller 11. For example, M/S converter 12 may perform LR-M/S conversion processing on the spectral parameters of the L-channel and R-channel based on the M/S conversion control information. M/S converter 12 outputs the spectral parameters (two channels) after the LR-M/S conversion processing to spectral encoder 13, for example.

Note that M/S converter 12 may perform LR-M/S conversion processing on every sub-band. Alternatively, the M/S conversion control information may include information indicating whether to perform LR-M/S conversion on every sub-band, and M/S converter 12 may perform LR-M/S conversion processing based on the M/S conversion control information. Alternatively, the M/S conversion control information may include information indicating whether to perform LR-M/S conversion on a plurality of sub-bands (e.g., some or all of sub-bands), and M/S converter 12 may perform LR-M/S conversion processing based on the M/S conversion control information.

Spectral encoder 13 performs processing of encoding the spectral parameters of the two channels inputted from M/S converter 12, and outputs the encoding result (e.g., referred to as “stereo FD encoding information”) to switching multiplexer 17. As an encoding process performed by spectral encoder 13, for example, a method described in section 5.3.3.2 in NPL 1 may be used for the MDCT spectrum, as in PTL 1.

In encoding apparatus 10, ITD adjuster 14, mixer 15, and CELP-based encoder 16 may constitute a stereo TD encoder (e.g., corresponding to a first encoder) that performs stereo TD encoding.

ITD adjuster 14 may receive, for example, L-channel and R-channel signals in the time domain after preprocessing, the ITD adjustment control information, and the analysis information from conversion/analysis/preprocessing/encoding controller 11. ITD adjuster 14 may, for example, perform, on the L-channel and R-channel signals, adjustment processing for reducing the absolute value of ITD to less than or equal to a threshold (e.g., adjustment processing for bringing the absolute value of ITD close to zero) based on the ITD adjustment control information (e.g., referred to as ITD adjustment processing). ITD adjuster 14 may output the L-channel and R-channel signals after the ITD adjustment processing to mixer 15. Note that exemplary ITD adjustment processing in ITD adjuster 14 will be described later.

Note that the ITD adjustment processing may be performed on the encoder side, and need not be performed on the decoder side (e.g., decoding processing need not be performed on the decoder side). Further, for example, at least one of an upper limit and a lower limit may be set on the maximum number of shifts (e.g., the number of samples) that can be adjusted (e.g., shiftable). For example, it is known that the angular resolution required for reproduction of speech in any three-dimensional radiation direction (e.g., also referred to as azimuthal perceptual resolution) is 30 degrees, as reported (e.g., see NPL 2). Then, for example, the range of ITD adjustment may be set so that the angle of the direction of arrival is within approximately 30 degrees. For example, for a signal of 48 KHz sampling, the adjustable range may be set to a range of up to ±three samples. Note that the range of ITD adjustment is not limited to ±three samples, and may be another value. Further, the azimuthal perceptual resolution that is referred to when the ITD adjustment range is set is not limited to 30 degrees.

Moreover, ITD adjuster 14 may, for example, perform clipping at an upper limit value or a lower limit value when ITD obtained by ITD analysis exceeds a set range.

In addition, in encoding apparatus 10, in addition to ITD adjustment processing, ILD adjustment processing for adjusting ILD between the L-channel and R-channel signals may be performed. For example, encoding apparatus 10 may adjust the amplitudes of the L-channel and R-channel signals so that the ILD between the both channel signals after ITD adjustment processing becomes zero, that is, the energies of the both channel signals are equal. For example, encoding apparatus 10 may adjust the amplitudes of the L-channel and R-channel signals to have the average energy of the energies of the both channel signals. When performing amplitude adjustment, encoding apparatus 10 may perform amplitude adjustment such that the amount of the amplitude adjustment is gradually increased from the frame starting point in order to avoid occurrence of discontinuity between frames.

In the amplitude adjustment, encoding apparatus 10 may calculate an amplitude adjustment coefficient (e.g., gain) and multiply each of the both channel signals after ITD adjustment processing by the calculated amplitude adjustment coefficient.

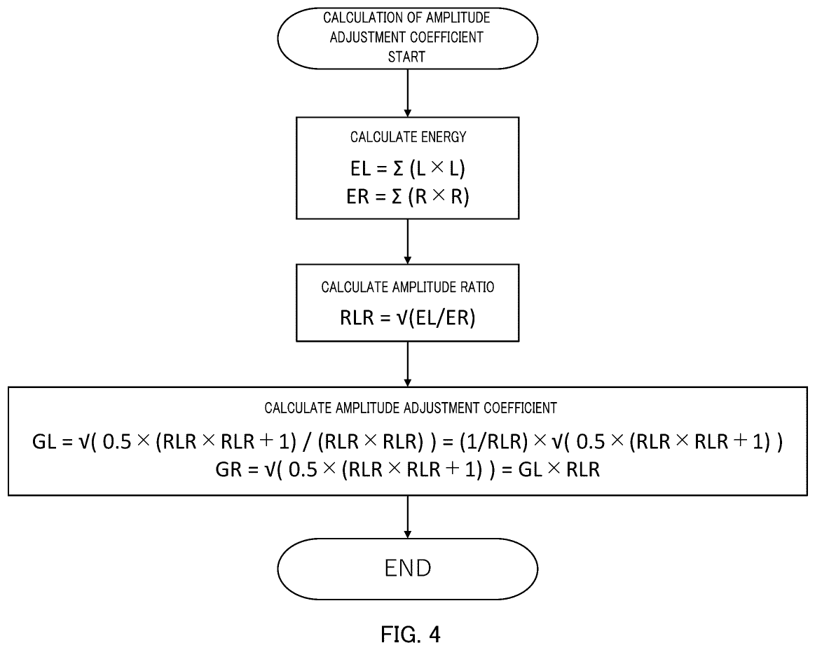

The calculation of the amplitude adjustment coefficient can be performed as illustrated in FIG. 4, for example. In FIG. 4, the procedure of calculating the amplitude adjustment coefficient includes an energy calculation step, an amplitude-ratio calculation step, and an amplitude adjustment coefficient calculation step.

In FIG. 4, in the energy calculation step, frame energies of the L-channel signal (L) and the R-channel signal (R) after the ITD adjustment processing are calculated (EL and ER) and outputted to the amplitude-ratio calculation step.

In the amplitude-ratio calculation step, the square root of the ratio between EL and ER is obtained and outputted to the amplitude adjustment coefficient calculation step as an amplitude ratio between L and R (RLR).

Note that, in the amplitude ratio calculation step, when the average energy, power, or magnitudes of the amplitudes of the both channel signals do not exceed a predetermined threshold, the amplitude ratio may be outputted as one without calculating the amplitude ratio. Thus, amplitude adjustment processing is not performed on a low-level signal, and unnecessary processing can be skipped.

In the amplitude adjustment coefficient calculation step, the square root of the ratio between the average value of the square of RLR and one (e.g., 0.5×(RLR×RLR+1)) and the square of RLR (e.g., RLR×RLR) is obtained and set as an amplitude adjustment coefficient for the L-channel (GL). Further, in the amplitude adjustment coefficient calculation step, an amplitude adjustment coefficient for the R-channel (GR) is obtained by multiplying the GL by RLR. Note that, in the amplitude adjustment coefficient step, in the case that the obtained GL is not within the range of a predetermined threshold (e.g., greater than or equal to a lower limit threshold and less than or equal to an upper limit threshold), clipping at the upper limit threshold may be performed when the GL exceeds the upper limit threshold, and clipping at the lower limit threshold may be performed when the GL is below the lower limit threshold. In this way, keeping the amplitude adjustment coefficient within a particular range can avoid an excessively large amplitude change by the amplitude adjustment.

Note that, as described above, the amplitude adjustment coefficient may be gradually changed from the amplitude adjustment coefficient used in the immediately preceding frame to the amplitude adjustment coefficient calculated for the current frame so that the signal after the amplitude adjustment is smoothly connected between the frames. Further, the procedure of calculating the amplitude adjustment coefficient is not limited to the processing illustrated in FIG. 4. Further, the amplitude adjustment coefficient is not limited to the value obtained by the processing illustrated in FIG. 4, and may be any value as long as the value is calculated so that the amplitudes (or energies) of both channel signals are equal.

As described above, encoding apparatus 10 may perform processing of bringing ITD close to zero (e.g., ITD adjustment processing) and processing of bringing ILD close to zero (e.g., ILD adjustment processing). This maximizes the correlation between the L-channel and R-channel signals after ITD adjustment processing, and can make the S channel signal after the conversion into an M/S stereo signal smaller, which enhances the encoding efficiency for stereo signals.

Mixer 15 may, for example, receive the L-channel and R-channel signals after ITD adjustment processing from ITD adjuster 14 and the mixing control information from conversion/analysis/preprocessing/encoding controller 11. Mixer 15 performs mixing processing between the L-channel and R-channel signals based on the mixing control information, and outputs the two-channel signals after the mixing processing to CELP-based encoder 16, for example. Exemplary mixing processing in mixer 15 will be described later.

CELP-based encoder 16 may encode each of the two channel signals inputted from mixer 15 (e.g., M/S signals obtained by converting the inputted stereo signal after ITD adjustment) using a CELP-based codec having a configuration of switching between CELP coding and MDCT coding (e.g., multi-mode coding, multi-mode codec, or multi-mode monaural codec), such as an Enhanced Voice Services (EVS) codec (see NPL 1). CELP-based encoder 16 may output a signal obtained by multiplexing the encoding results of the channels (e.g., “stereo TD encoding information”) to switching multiplexer 17.

Switching multiplexer 17 may, for example, multiplex information to be transmitted, among the M/S conversion control information and the mixing control information inputted from conversion/analysis/preprocessing/encoding controller 11, the stereo FD encoding information inputted from spectral encoder 13, and the stereo TD encoding information inputted from CELP-based encoder 16, based on the encoding control information inputted from conversion/analysis/preprocessing/encoding controller 11, and may output the multiplexed information to a transmission path such as a communication channel or a recording medium such as a storage medium.

Note that, in encoding apparatus 10, for example, either one of the stereo FD encoding information and the stereo TD encoding information may be inputted to switching multiplexer 17 based on the encoding control information.

### [Exemplary Processing of Encoding Apparatus 10]

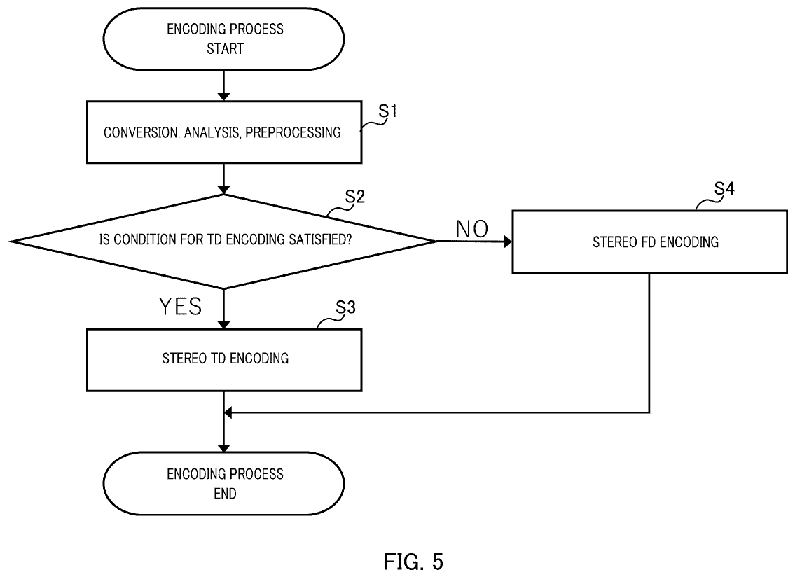

FIG. 5 is a flowchart illustrating an exemplary processing procedure of encoding apparatus 10.

Conversion/analysis/preprocessing/encoding controller 11 performs, for example, conversion processing, analysis processing, and preprocessing on the L-channel and R-channel signals (S1).

For example, encoding apparatus 10 determines whether the target frame is a frame using stereo TD encoding (S2). For example, encoding apparatus 10 may determine whether the condition for applying stereo TD encoding is satisfied. Alternatively, for example, encoding apparatus 10 may determine whether the condition for applying stereo FD encoding is satisfied.

Encoding apparatus 10 may determine whether to use stereo TD encoding based on, for example, the analysis result of the inter-channel cross correlation (ICC) between the L-channel and the R-channel, and the determination may be based on an LR/MS determination algorithm used for stereo FD encoding (e.g., method for determining M/S conversion control). For example, when the inter-channel cross correlation (ICC) is high (e.g., when the value of ICC is greater than or equal to a threshold), encoding apparatus 10 may determine that the condition for applying stereo TD encoding is satisfied, and when the inter-channel cross correlation (ICC) is low (e.g., when the value of ICC is less than the threshold), encoding apparatus 10 may determine that the condition for applying stereo TD encoding is not satisfied.

Further, encoding apparatus 10 may analyze, in analysis processing, whether the type of the input stereo signal is a speech signal, for example. The condition for applying stereo TD encoding may be based on, for example, the type of the input stereo signal. For example, encoding apparatus 10 may determine that the condition for applying stereo TD encoding is satisfied when the type of the input stereo signal is a speech signal, and may determine that the condition for applying stereo TD encoding is not satisfied when the type of the input stereo signal is not a speech signal.

Further, the condition for applying stereo TD encoding may be based on, for example, an inter-channel time difference (ITD) of the input stereo signal. For example, encoding apparatus 10 may determine that the condition for applying stereo TD encoding is satisfied when the value of ITD obtained from ITD analysis is within a preset threshold range that is in the vicinity of zero, and determines that the condition for applying stereo TD encoding is not satisfied when the value of ITD is outside the preset threshold range.

Note that the preset range may be, for example, a range expanded to approximately within 50% of the above-described adjustable range of the ITD adjustment processing (e.g., range based on the perceptual resolution). Alternatively, the preset range may be configured so that, when the ITD changes from within the predetermined range to outside the range, or when the ITD changes from outside the predetermined range to within the range, the determination result is changed after the post-change state continues for a predetermined number of frames. This is to avoid frequent switching between stereo FD encoding and stereo TD encoding between frames for an input signal whose ITD changes near the boundary of the ITD range.

In addition, the condition for applying stereo TD encoding may be based on, for example, a bit rate for the input stereo signal. For example, encoding apparatus 10 may determine that the condition for applying stereo TD encoding is satisfied when a bit rate is less than or equal to a threshold, and may determine that the condition for applying stereo TD encoding is not satisfied when the bit rate is greater than the threshold.

Further, the condition for applying stereo TD encoding may be based on, for example, at least one of the above-described ICC, LR/MS determination algorithm, type of the input stereo signal, ITD, and bit rate.

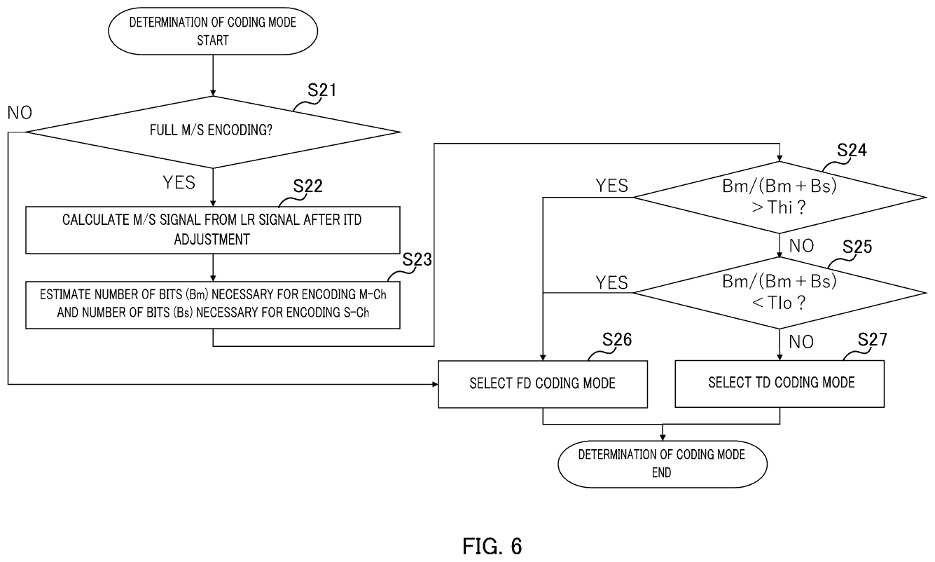

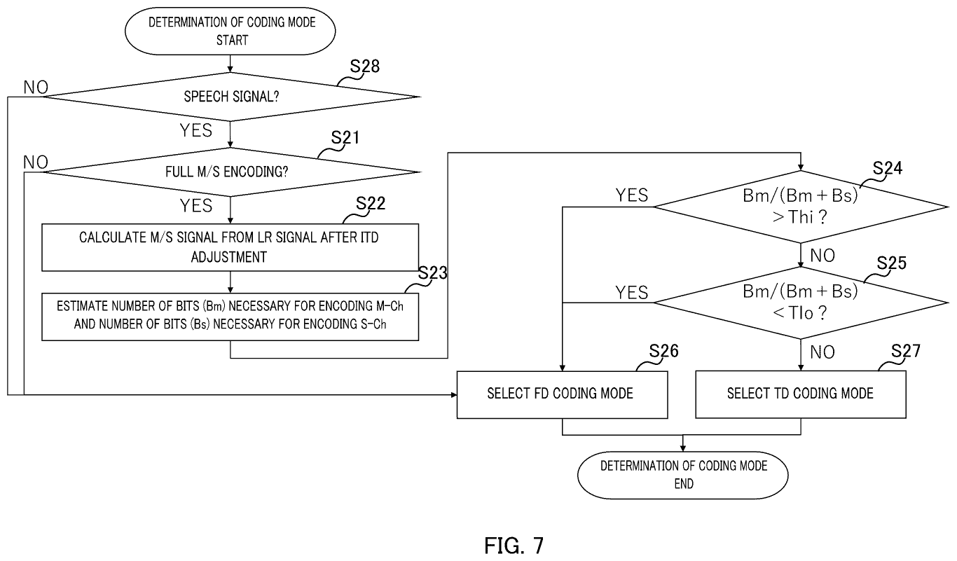

In addition, a condition for applying stereo TD encoding may be based on, for example, a numerical value calculated by using the number of bits estimated to be necessary for encoding the signal of the Mid-channel and the number of bits estimated to be necessary for encoding the signal of the Side-channel. FD/TD determiner 106 in FIGS. 2 and 3 may determine the coding mode by using, for example, a processing flow illustrated in FIG. 6 or FIG. 7.

In FIG. 6, for example, FD/TD determiner 106 checks whether the M/S determination result inputted from M/S determiner 102 is a full M/S coding mode (S21), and in a case where the M/S determination result is not a full M/S coding mode (S21: NO), selects an FD coding mode (S26).

On the other hand, in the case of the full M/S coding mode (S21: YES), FD/TD determiner 106 calculates an M/S stereo signal from the stereo signal converted into the frequency domain, which is inputted from second converter 105 (S22). In FIGS. 2 and 3, the calculation of the M/S stereo signal is performed after the conversion into the frequency domain, but the calculation of the M/S stereo signal may be performed in the time domain first, and then the conversion into the frequency domain may be performed.

Next, FD/TD determiner 106 estimates the number of bits Bm to be necessary for encoding the signal of the Mid-channel of the M/S stereo signal and the number of bits Bs to be necessary for encoding the signal of the Side-channel (S23). As an estimation method, for example, the method disclosed in PTL 1 can be used.

Next, FD/TD determiner 106 determines whether the value of Bm/(Bm+Bs) exceeds threshold Thi (or is equal to or greater than threshold Thi) (S24), and selects the FD coding mode in a case where the value of Bm/(Bm+Bs) exceeds Thi (or is equal to or greater than Thi) (S24: YES) (S26). The value Thi needs only be a value close to 1, and is set to, for example, 0.90. The fact that the value of Bm/(Bm+Bs) exceeds threshold Thi or is equal to or greater than threshold Thi means that most of the input signal is included in the Mid-channel side and is a stereo signal similar to dual-mono. For such a stereo signal, since the signal of the Mid-channel can be encoded with a sufficient number of bits, the FD coding mode is selected. The value of threshold Thi is not limited to 0.90, and may be, for example, 0.85.

On the other hand, in a case where the value of Bm/(Bm+Bs) does not exceed threshold Thi (or is equal to or less than threshold Thi) (S24: NO), FD/TD determiner 106 determines whether the value of Bm/(Bm+Bs) falls below threshold Tlo (or is equal to or less than threshold Tlo) (S25), and selects the FD coding mode in a case where the value of Bm/(Bm+Bs) falls below Tlo (or is equal to or less than Tlo) (S25: YES) (S26). The value of Tlo needs only be a value of 0.5 or a value slightly greater than 0.5, and is set to, for example, 0.65. The fact that the value of Bm/(Bm+Bs) does not exceed threshold Tlo or is equal to or less than threshold Tlo means that the input signal is a stereo signal for which both the signals of the Mid-channel and the Side-channel of the M/S stereo signal require bits for encoding, without being biased toward the Mid-channel. For such a stereo signal, a TD coding mode, which involves waveform coding in the time domain, is more prone to degradation in stereo localization and perceived audio quality due to encoding errors. Thus, the FD coding mode is more advantageous. Therefore, FD/TD determiner 106 selects the FD coding mode. The value of threshold Tlo is not limited to 0.65, and may be, for example, 0.60.

On the other hand, in a case where the value of Bm/(Bm+Bs) exceeds threshold Tlo and does not exceed threshold Thi (or in a case where the value of Bm/(Bm+Bs) is equal to or greater than threshold Tlo and equal to or less than threshold Thi) (S24: NO and S25: NO), FD/TD determiner 106 selects the TD coding mode (S27). This is because, in this case, while a large number of bits can be allocated to the Mid-channel side, it is necessary to allocate a certain number of bits to the Side-channel side, and there is a possibility that the number of bits is insufficient for high-quality encoding of the signal of the Mid-channel side in the FD coding mode. In particular, in a case where the input signal is a speech signal, the possibility is high. Therefore, FD/TD determiner 106 selects the TD coding mode in which the speech signal can be encoded with high quality even with a smaller number of bits.

In addition, FIG. 7 is a processing flow in which a step (S28) of determining whether the type of the input signal is a speech signal is added to the determination procedure in FIG. 6 as a first processing step. In a case where the type of the input signal is determined to be a speech signal (S28: YES), FD/TD determiner 106 proceeds to the determination step (S21) for the full M/S coding mode. On the other hand, in a case where it is determined that the type of the input signal is not a speech signal (S28: NO), FD/TD determiner 106 determines to select the FD coding mode (S26).

In a case where it is determined that the input signal is not a speech signal (S28: NO), FD/TD determiner 106 may change threshold Thi and threshold Tlo and proceed to the processing of S21, without determining to select the FD coding mode. In this case, at least one of threshold Thi or threshold Tlo may be changed so that a difference between threshold Thi and threshold Tlo is reduced (e.g., such that the values of threshold Thi and threshold Tlo approach each other). For example, in a case where an initial value of Thi is 0.90 and an initial value of Tlo is 0.65, Thi may be changed to 0.68 and Tlo may be changed to 0.66.

The values of Thi and Tlo can be determined based on the encoding bit rate of the M signal and the encoding bit rate of the S signal in the TD coding mode. In a case where the encoding bit rate of the M signal in the TD coding mode is denoted by BmTD and the encoding bit rate of the S signal in the TD coding mode is denoted by BsTD, the values of Thi and Tlo may be set above and below a value of BmTD/(BmTD+BsTD). For example, in a case where the bit rate of the M signal is 32 kbps and the bit rate of the S signal is 16 kbps, BmTD/(BmTD+BsTD)=0.67, and thus Thi may be set to 0.68 (Thi=0.68) and Tlo may be set to 0.66 (Tlo=0.66). In a case where the input signal is determined to be a speech signal, the range may be widened, such as Thi=0.90 and Tlo=0.65.

In addition, for example, in a case where it is determined that the input signal is a music signal, the interval between Thi and Tlo may be widened with the elapse of time (as each processing frame advances), after Thi is set to 0.68 and Tlo is set to 0.66. For example, in a case where Thi is increased by 0.01 as each frame advances, the threshold can be controlled so that Thi=0.90 after 22 frames. For example, a value to be increased for each frame and an upper limit value for Thi need only be determined. Also for Tlo, a value to be decreased for each frame and a lower limit value need only be determined. This allows encoding apparatus 10 to switch between the stereo TD encoding and the stereo FD encoding according to the input signal even in a case where speech/music determiner 108 is present only in the stereo TD encoder. Note that Thi and Tlo may be changed to a predetermined interval (e.g., Thi=0.9, Tlo=0.65) after a predetermined number of frames has elapsed, without being changed for each frame. For example, in a case where the input signal is determined to be a music signal, the interval between Thi and Tlo may be changed (e.g., setting to narrow the interval between Thi and Tlo), and after 5 seconds from the change, the interval between Thi and Tlo may be changed to a predetermined interval. Furthermore, in a case where the interval between Thi and Tlo is gradually widened, for example, by fixing Tlo to 0.65 and increasing Thi from 0.66 by 0.001 for each frame, Thi can be set to 0.90 after 240 frames. For example, in a case where one frame is 20 ms, 240 frames correspond to 4.8 seconds. In addition, for example, Thi may be increased by 0.01 for every 10 frames. Furthermore, in a case where the input speech signal is determined to be a speech signal in a state where the interval between Thi and Tlo is narrowed, for example, the interval may be changed to a predetermined interval, such as Thi=0.9 and Tlo=0.65.

The period (e.g., the number of frames) and the amount of change for changing the interval between Thi and Tlo (e.g., at least one of values of Thi and Tlo) are not limited to the above-described examples. In addition, the period in which the interval between Thi and Tlo is gradually changed may have equal intervals (or may be periodic) or unequal intervals (or may be non-periodic). In addition, the amount of change in the interval between Thi and Tlo for each predetermined period may be the same or different.

The step of determining whether the type of the input signal is a speech signal need not be performed at the beginning of the processing flow in FIG. 7, and may be incorporated into the determination step (S21) of whether the full M/S coding mode is used (e.g., may determine whether the input signal is a speech signal and the full M/S coding mode is used). The determination of whether the type of the input signal is a speech signal is performed by, for example, speech/music determiner 108 in FIG. 3, and information on the determination result is inputted to FD/TD determiner 106.

As described above, in a case where the TD coding mode is determined to be applied, encoding apparatus 10 converts the LR stereo signal into the M/S stereo signal for the stereo speech signal, and encodes the Mid-signal and the Side-signal using the CELP-based encoder. In FIGS. 6 and 7, a case has been described in which the determination of whether the value of Bm/(Bm+Bs) exceeds threshold Tlo (or whether the value is equal to or greater than Tlo) is performed, and then the determination of whether the value of Bm/(Bm+Bs) exceeds threshold Thi (or whether the value is equal to or less than Thi) is performed, but the determinations may be performed in the reverse order, or it may be determined whether the value of Bm/(Bm+Bs) is within a certain numerical range at once. In this way, by selecting the TD coding mode only in a case where the value of Bm/(Bm+Bs) is within a certain numerical range, the TD coding mode can be selected only when there is a definite advantage in performing the CELP coding, thereby enhancing the coding performance.

In FIG. 5, for example, in a case where the frame is determined to be a frame that uses stereo TD encoding (S2: YES), encoding apparatus 10 performs stereo TD encoding processing (S3). For example, in a case where the stereo TD encoding described above is determined to be applied, encoding apparatus 10 may determine to convert the LR stereo signal into the M/S stereo signal for the stereo speech signal, and encode the Mid-signal and the Side-signal using the CELP-based encoder (e.g., CELP-based encoder 16).

For example, in an EVS codec, which is a monaural system, Algebraic CELP (ACELP) is used for speech coding up to 64 kbit/s (e.g., see NPL 1). Further, it is known that, regarding the coding performance for speech signals, the performance of CELP coding is higher than that of another coding at lower to medium bit rates. Thus, as described above, encoding apparatus 10 can enhance the coding performance for speech signals by performing CELP-based stereo TD encoding when the condition is satisfied.

Note that, in the stereo TD encoding, for example, encoding apparatus 10 may apply the CELP-based coding to the Mid-signal and apply coding different from the CELP-based coding to the Side-signal, for a stereo speech signal having high inter-channel cross correlation.

On the other hand, when encoding apparatus 10 does not determine that the frame uses stereo TD encoding (S2: NO), stereo FD encoding processing is performed (S4).

The processing of encoding apparatus 10 has been described above.

### [Exemplary Processing of Stereo TD Encoding]

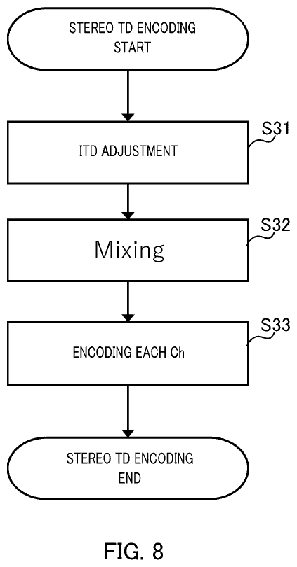

FIG. 8 is a flowchart illustrating an exemplary processing procedure of stereo TD encoding (e.g., process of S3 illustrated in FIG. 5).

Encoding apparatus 10 performs ITD adjustment processing for adjusting ITD (absolute value of ITD) to less than or equal to a threshold on the L-channel and R-channel signals (S31).

Encoding apparatus 10 performs mixing processing (e.g., LR to M/S conversion processing in the time domain) on the R-channel and L-channel signals after the ITD adjustment (S32).

Encoding apparatus 10 performs encoding processing on the two channel signals after the mixing processing, for example (S33).

### [Exemplary Processing of ITD Adjustment]

ITD adjustment processing is performed, for example, after the frame to be encoded is determined to be a frame in which stereo TD encoding is performed (e.g., referred to as “stereo TD encoding frame”). At this time, the stereo TD encoding frame can be classified into the following three types.
(1) The first stereo TD frame (hereinafter, also referred to as “first frame”) after switching from a frame in which stereo FD encoding processing is performed (e.g., referred to as “stereo FD encoding frame”).
(2) A frame following and followed by a stereo TD encoding frame (hereinafter, also referred to as “second frame”). The second frame may be, for example, a frame of which the previous and subsequent frames are not stereo FD frames.
(3) The last stereo TD encoding frame (hereinafter, also referred to as “third frame”). The third frame may be a frame that is to switch to a stereo FD encoding frame in a subsequent frame.

ITD adjustment processing methods for these three types of frames may be different from each other.

For the first frame of (1) described above, an MDCT-based coding mode may be selected by CELP-based encoder 16 as described later, in order to seamlessly connect frames from a stereo FD encoding frame to a stereo TD encoding frame. In the first frame, in a case where ITD is not zero, ITD adjustment processing may be performed to bring ITD close to zero.

At the second frame of (2) described above, the immediately preceding frame is a stereo TD encoding frame, and thus it is highly likely that ITD adjustment processing has been applied. Therefore, encoding apparatus 10 may, for example, perform adjustment processing such that the signal of one of the channels is gradually delayed (waveform is shifted to the future direction on the time axis) or gradually advanced (waveform is shifted to the past direction on the time axis), depending on the difference (change) between the ITD in the immediately preceding frame and the ITD in the current frame. For example, when there is no change in ITD between the immediately preceding frame and the current frame (e.g., when the difference (absolute value of the difference) is within a threshold or zero), encoding apparatus 10 need not perform the ITD adjustment processing that gradually changes the signal (e.g., the shift amount of the immediately preceding frame may be maintained).

Further, for example, encoding apparatus 10 may set an upper limit on an ITD adjustment amount (e.g., the number of samples by which one channel signal is delayed) in order to suppress a sudden change in the signal due to the adjustment processing. For example, encoding apparatus 10 may set (e.g., limit) an upper limit (e.g., maximum value) on the number of adjustable samples per frame to one sample. In this case, two or more frames are required to adjust ITD of more than one sample.

For the third frame of (3) described above, because encoding is to be switched to stereo FD encoding in the subsequent frame, ITD adjustment processing is preferably performed so as to restore the adjusted ITD. For example, unlike the first and second frames, in the third frame, the upper limit (e.g., limitation or restriction) on the number of samples to be restored per frame may be removed in order to restore ITD in one frame. For example, encoding apparatus 10 performs processing of gradually advancing (shifting to the past direction on the time axis) the channel that has been delayed by the ITD adjustment processing (shifted to the future direction on the time axis) and returning to the original position.

As described above, encoding apparatus 10 may perform ITD adjustment that gradually shifts a time signal within one sample, on frames other than the third frame immediately preceding the frame in which stereo FD encoding is performed, among a plurality of stereo TD encoding frames (e.g., sections).

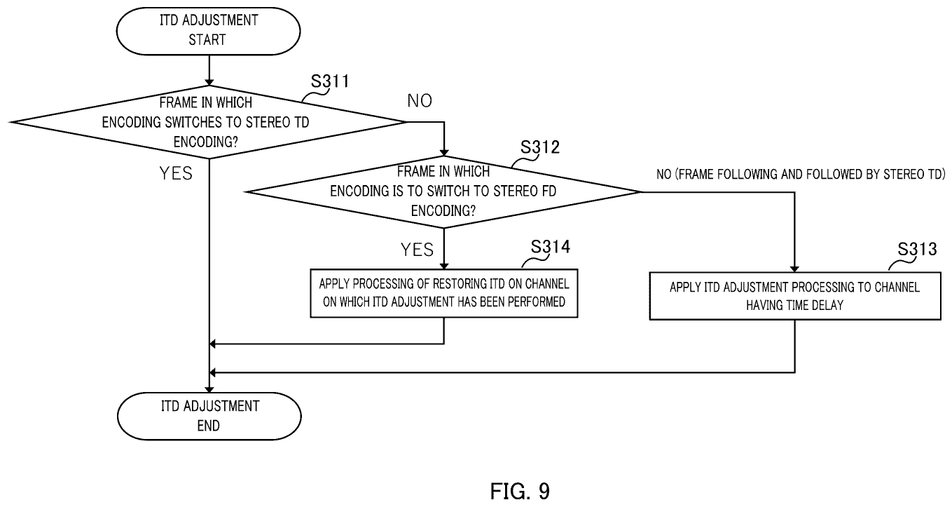

FIG. 9 is a flowchart illustrating an exemplary processing procedure of the above-described ITD adjustment processing (e.g., process of S31 illustrated in FIG. 8).

In FIG. 9, encoding apparatus 10 determines, for example, whether the frame is the first frame in which encoding switches to stereo TD encoding (S311).

When the frame is a frame in which encoding switches to stereo TD encoding (S311: YES), encoding apparatus 10 need not perform ITD adjustment processing (e.g., end ITD adjustment processing). Note that, as described above, encoding apparatus 10 may perform ITD adjustment processing on this frame. In this case, the process of S311 need not be performed, and the first frame may be treated the same as the second frame.

When the frame is not a frame in which encoding switches to stereo TD encoding (S311: NO), encoding apparatus 10 determines, for example, whether the frame is the third frame, in which encoding is to switch to stereo FD encoding (S312).

When the frame is not a frame in which encoding is to switch to stereo FD encoding (S312: NO), for example, when the frame is the second frame, encoding apparatus 10 may perform ITD adjustment processing (S313).

When the frame is the third frame, in which encoding is to switch to stereo FD encoding (S312: YES), encoding apparatus 10 may perform processing of restoring ITD on the channel on which ITD adjustment has been performed (S314). By this processing, the input signal is consequently outputted as it is, and then ITD adjustment processing ends.

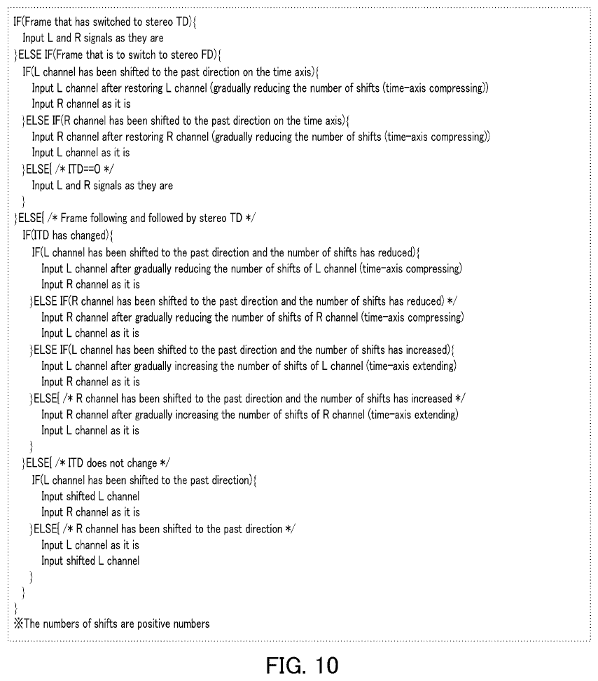

FIG. 10 illustrates a processing flow of the ITD adjustment processing illustrated in FIG. 9 using a pseudo program code.

Note that, in ITD adjustment processing, processing of advancing a signal (e.g., processing of shifting a signal to the past direction on the time axis) and processing of delaying a signal (e.g., processing of shifting a signal to the future direction on the time axis) may be performed, for example, at a resolution of less than one sample to realize a smooth change. This can be performed using an interpolation filter that interpolates between samples. For example, this can be implemented similarly to a long-term prediction filter for fractional delays used in a known CELP codec.

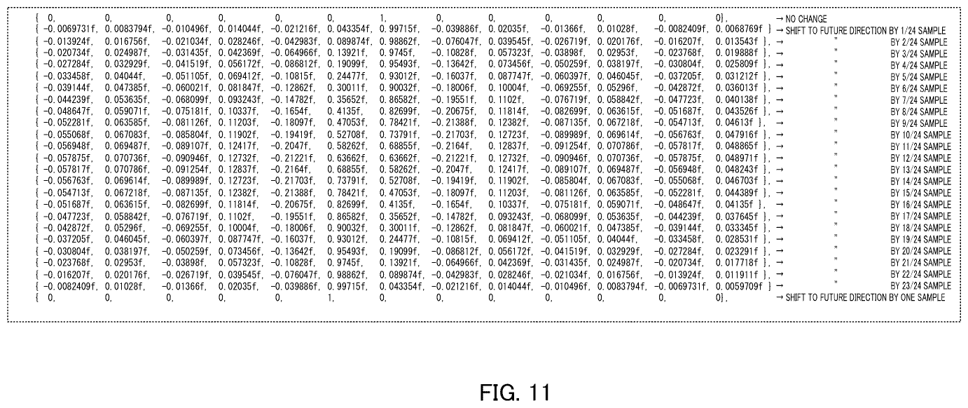

FIG. 11 illustrates an exemplary coefficient set of an interpolation filter (e.g., FIR filter) that performs interpolation using a total of 13 samples with six samples before and after a sample at a 1/24 sample accuracy. The interpolation filter is equivalent to a time-axis inversion of the impulse response of a delay filter that delays a signal with a 1/24 sample accuracy. Note that, a filter of a coefficient set composed of zero and one is described for convenience in FIG. 11, but need not be implemented (e.g., because the input and output do not change or the signal is shifted only by one sample, the filter need not be applied as filtering processing).

For example, when the signal is gradually shifted (or delayed) to the future direction of the time axis by 1/24 sample at a time, the signal can be consequently shifted (delayed) by one sample time by gradually switching from the coefficient set above to the coefficient set below among the coefficient sets illustrated in FIG. 11. For example, in the case that the filter is switched every five samples in 48 KHz sampling, the signal can be shifted by one sample over 2.5 ms.

On the other hand, for example, when the signal is gradually shifted to the past direction on the time axis by 1/24 sample at a time, the signal can be consequently advanced by one sample time by gradually switching from the coefficient set below to the coefficient set above among the coefficient sets illustrated in FIG. 11.

### [Switching of Coding Modes]

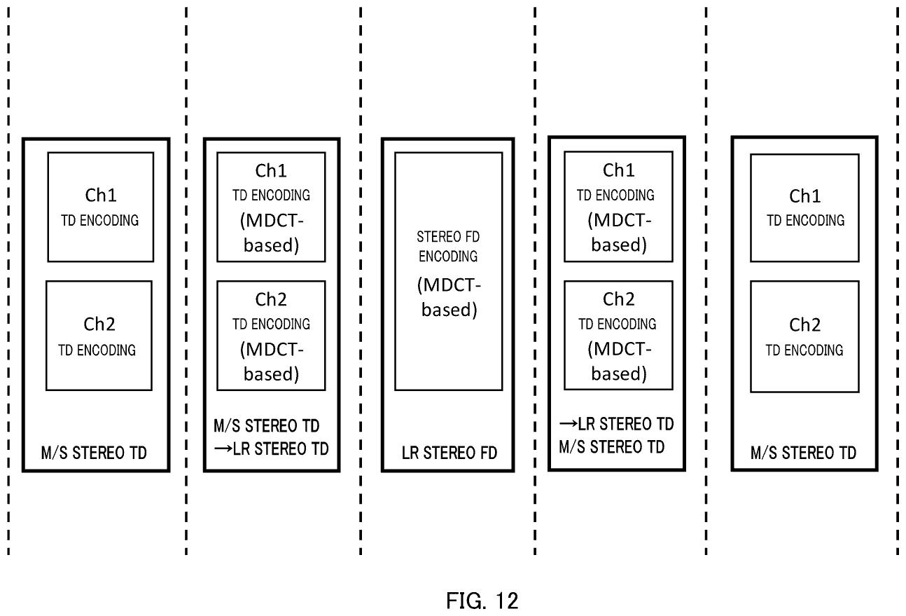

FIG. 12 illustrates a state of switching coding modes over five frames in which the three types of stereo TD encoding frames and a stereo FD encoding frame are switched. Time elapses from the left end to the right end in FIG. 12, and the frames are separated by broken lines.

In the example illustrated in FIG. 12, the left-end frame (the first frame from the left) is the second frame of the stereo TD encoding frames described above. Further, the second frame from the left is a stereo TD encoding frame immediately before switching to a stereo FD encoding frame (third frame). Furthermore, the third frame from the left is a stereo FD encoding frame. The fourth frame from the left is stereo TD encoding (first frame) immediately after switching from the stereo FD encoding frame. The fifth frame from the left (the right-end frame) is the second frame of the stereo TD encoding frames similarly to the left-end frame.

In the second frame from the left (third frame) illustrated in FIG. 12, for example, it is preferred to provide a section (e.g., “M/S->LR transition section”) in which the signal gradually changes from an M/S stereo signal to an LR stereo signal. For example, in the second frame from the left illustrated in FIG. 12, encoding apparatus 10 may perform M/S→LR transition mixing processing (example will be described later). In the M/S→LR transition mixing processing, for a seamless (or smooth) connection to the subsequent stereo FD encoding frame, an MDCT-based coding mode similar to that in stereo FD encoding may be configured for encoding, for example. The MDCT-based coding mode may include, for example, MDCT-based Transform coded excitation (TCX) mode for the EVS codec.

Further, in the fourth frame illustrated in FIG. 12 (first frame), for example, it is preferred to provide a section (e.g., “LR->M/S transition section”) in which the signal gradually changes from an LR stereo signal to an M/S stereo signal. For example, in the fourth frame from the left illustrated in FIG. 12, encoding apparatus 10 may perform LR→M/S transition mixing processing (example will be described later). In the LR→M/S transition mixing processing, for a seamless (or smooth) connection to the immediately preceding stereo FD encoding frame, an MDCT-based coding mode similar to that in stereo FD encoding may be configured for encoding, for example.

As described above, encoding apparatus 10 may perform MDCT-based coding of the stereo TD coding mode in a frame adjacent to a frame in which the stereo FD coding mode is applied, among a plurality of consecutive frames (e.g., sections) in which the stereo TD coding mode is applied. For example, encoding apparatus 10 may perform encoding based on the coding mode in stereo FD encoding (e.g., MDCT-based coding mode) in at least one of an M/S->LR transition section in which encoding is switched from stereo TD encoding to stereo FD encoding and/or an LR->M/S transition section in which encoding is switched from stereo FD encoding to stereo TD encoding, among frames in which stereo TD encoding is performed.

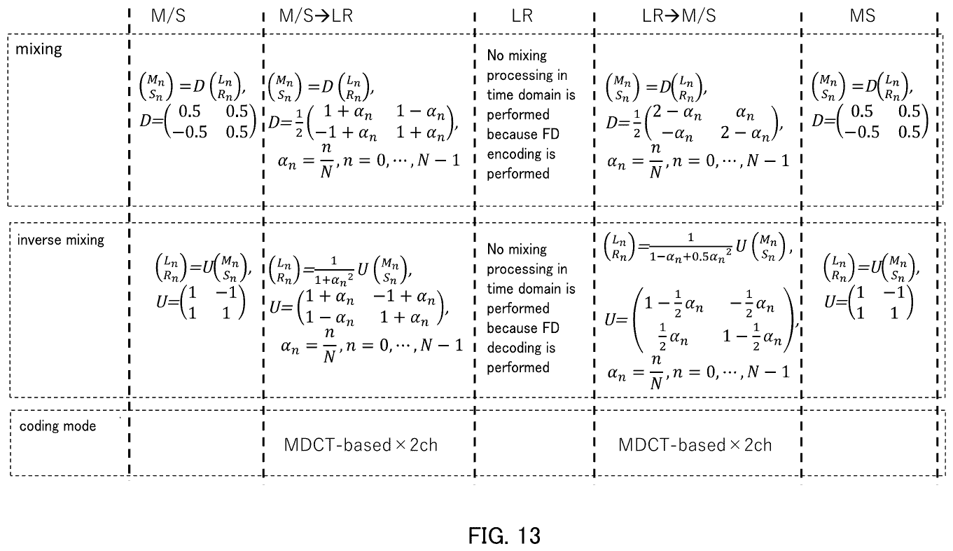

FIG. 13 illustrates exemplary mixing processing (processing on the encoding side)

and inverse mixing processing (processing on the decoding side) corresponding to the switching transition between stereo TD encoding and stereo FD encoding illustrated in FIG. 12. Time elapses from the left end to the right end of FIG. 13, and the frames are separated by broken lines. Further, the types of the five frames illustrated in FIG. 13 (e.g., any of a stereo FD encoding frame and the first to third frames of stereo TD encoding frames) are the same as those illustrated in FIG. 12.

For example, general LR→M/S conversion processing may be performed on the left-end and right-end frames corresponding to the second frame following and followed by a stereo TD encoding frame among stereo TD encoding frames illustrated in FIG. 13.

At this time, the channel conversion processing (mixing processing) is expressed by, for example, the following Equation 1.

$$[ 1 ]$$

$$( \begin{matrix}{M}_{n} \\ {S}_{n}\end{matrix} ) = D ( \begin{matrix}{L}_{n} \\ {R}_{n}\end{matrix} ) , \qquad ( Equation 1 )$$

$$D = ( \begin{matrix}0.5 & 0.5 \\ - 0.5 & 0.5\end{matrix} )$$

In Equation 1, the Ln and R, respectively represent an L-channel signal and an R-channel signal before the conversion processing, and the subscript n represents a time (sample number). Further, in Equation 1, the Mn and Sn respectively represent an M-channel signal and an S-channel signal after the conversion processing.

For example, channel conversion processing (mixing processing) expressed by the following Equation 2 may be performed on the second frame from the left corresponding to the third frame that corresponds to the M/S→LR transition section, among stereo TD encoding frames illustrated in FIG. 13.

$$[ 2 ]$$

$$( \begin{matrix}{M}_{n} \\ {S}_{n}\end{matrix} ) = D ( \begin{matrix}{L}_{n} \\ {R}_{n}\end{matrix} ) , \qquad ( Equation 2 )$$

$$D = \frac{1}{2} ( \begin{matrix}1 + {α}_{n} & 1 - {α}_{n} \\ - 1 + {α}_{n} & 1 + {α}_{n}\end{matrix} ) ,$$

$${α}_{n} = \frac{n}{N} , n = 0 , ⋯ , N - 1$$

The letter N herein represents a frame length (or transition section length). Transition section length N may be, for example, shorter than one frame or longer than one frame.

By the mixing processing expressed by Equation 2, the stereo signal gradually transitions from an M/S signal to an LR signal over time n.

For example, channel conversion processing (mixing processing) expressed by the following Equation 3 may be performed on the fourth frame from the left corresponding to the first frame that corresponds to the LR→M/S transition section, among stereo TD encoding frames illustrated in FIG. 13.

$$[ 3 ]$$

$$( \begin{matrix}{M}_{n} \\ {S}_{n}\end{matrix} ) = D ( \begin{matrix}{L}_{n} \\ {R}_{n}\end{matrix} ) , \qquad ( Equation 3 )$$

$$D = \frac{1}{2} ( \begin{matrix}2 - {α}_{n} & {α}_{n} \\ - {α}_{n} & 2 - {α}_{n}\end{matrix} ) ,$$

$${α}_{n} = \frac{n}{N} , n = 0 , ⋯ , N - 1$$

The letter N herein represents a frame length (or transition section length). Transition section length N may be, for example, shorter than one frame or longer than one frame.

By the mixing processing expressed by Equation 3, the stereo signal gradually transitions from an LR signal to an M/S signal over time n.

As described above, performing transition of the coding modes and the mixing processing makes it possible to seamlessly switch between CELP coding and MDCT coding and switch between M/S stereo and LR stereo in stereo TD encoding frames and stereo FD encoding frames.

### [Exemplary Configuration of Decoding System]

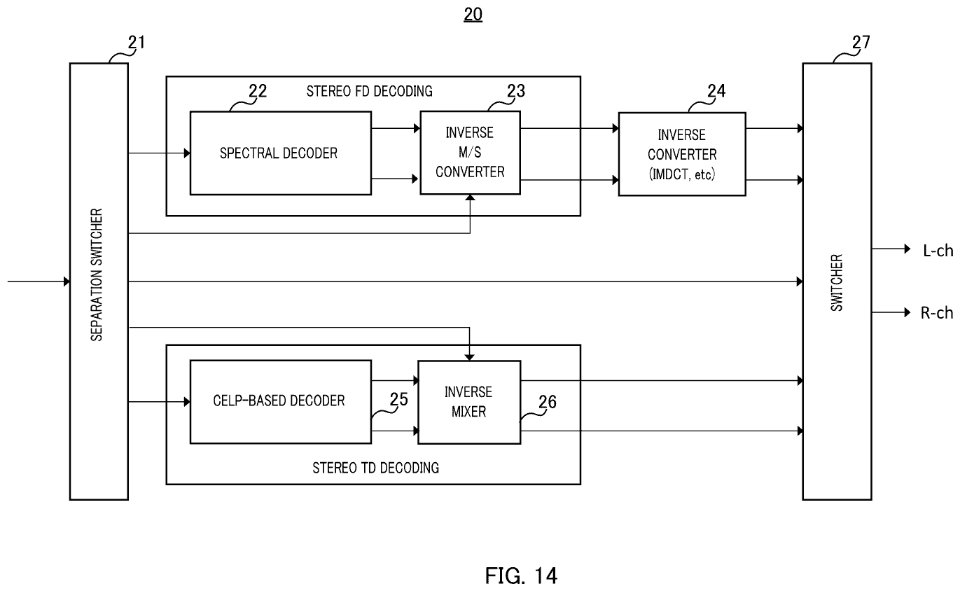

FIG. 14 illustrates an exemplary configuration of a decoding apparatus (also referred to as “decoding system”) 20.

Decoding apparatus 20 may include, for example, separation switcher 21, spectral decoder 22, inverse M/S converter 23, inverse converter 24, CELP-based decoder 25, inverse mixer 26, and switcher 27.

Separation switcher 21 receives, for example, multiplexed encoding information from a transmission path such as a communication channel or a recording medium such as a storage medium. Separation switcher 21 may, for example, separate the encoding information into a plurality of pieces of control information and switch output destinations of the separated pieces of control information.

For example, when the encoding information includes stereo FD encoding information, separation switcher 21 may output the stereo FD encoding information (e.g., spectral coding information) to spectral decoder 22 and output M/S conversion control information to inverse M/S converter 23.

Further, for example, when the encoding information includes stereo TD encoding information, separation switcher 21 may output the stereo TD encoding information (e.g., encoding information of CELP-based encoder 16) to CELP-based decoder 25 and output mixing control information to inverse mixer 26.

Further, separation switcher 21 may, for example, output information indicating which of the stereo FD encoding information and stereo TD encoding information has been transmitted (or which of the stereo FD encoding and stereo TD encoding has been applied) to switcher 27.

In decoding apparatus 20, spectral decoder 22 and inverse M/S converter 23 may constitute a stereo FD decoder that decodes stereo encoding information in the frequency domain (e.g., referred to as “stereo FD decoding”).

For example, spectral decoder 22 receives the spectral coding information outputted from separation switcher 21, decodes spectral information of two channels, and outputs the decoded information to inverse M/S converter 23.

Inverse M/S converter 23 receives the decoded spectra of the two channels outputted from spectral decoder 22 and the M/S conversion control information outputted from separation switcher 21, performs inverse M/S conversion on the decoded spectra of the two channels based on the M/S conversion control information, and outputs LR stereo spectra (e.g., MDCT spectra) to inverse converter 24.

For example, inverse converter 24 receives the LR stereo signals (MDCT spectra) outputted from inverse M/S converter 23, performs inverse conversion (e.g., Inverse MDCT (IMDCT)) processing, and outputs the LR stereo signals (time signals) to switcher 27.

In decoding apparatus 20, CELP-based decoder 25 and inverse mixer 26 may constitute a stereo TD decoder that decodes stereo encoding information in the time domain (e.g., referred to as “stereo TD decoding”).

For example, CELP-based decoder 25 receives the encoding information of CELP-

based encoder 16 outputted from separation switcher 21, decodes the two-channel speech signals, and outputs the decoded speech signals to inverse mixer 26.

For example, inverse mixer 26 receives the decoded two-channel speech signals outputted from CELP-based decoder 25, performs inverse mixing processing on the decoded two-channel speech signals based on the mixing control information outputted from separation switcher 21, reconfigures LR stereo signals, and outputs the reconfigured signals to switcher 27.

For example, switcher 27 receives the information outputted from separation switcher 21, receives the decoded LR stereo signals from either inverse converter 24 or inverse mixer 26 depending on the information, and outputs the decoded stereo signals as final LR stereo signals (e.g., L-channel and R-channel signals).

Note that, as described above, decoding apparatus 20 (decoding system) need not perform processing corresponding to ITD adjustment processing performed in stereo TD encoding (e.g., inverse adjustment processing for restoring adjusted ITD).

Further, exemplary inverse mixing processing corresponding to switching transition between stereo TD decoding and stereo FD decoding is illustrated in FIG. 13.

For example, general M/S→LR conversion processing may be performed on the left-end and right-end frames corresponding to the second frame following and followed by a stereo TD encoding frame among stereo TD encoding frames illustrated in FIG. 13.

At this time, the channel conversion processing (inverse mixing processing) is expressed by, for example, the following Equation 4.

$$[ 4 ]$$

$$( \begin{matrix}{L}_{n} \\ {R}_{n}\end{matrix} ) = U ( \begin{matrix}{M}_{n} \\ {S}_{n}\end{matrix} ) , \qquad ( Equation 4 )$$

$$U = ( \begin{matrix}1 & - 1 \\ 1 & 1\end{matrix} )$$

For example, channel conversion processing (inverse mixing processing) expressed by the following Equation 5 may be performed on the second frame from the left corresponding to the third frame that corresponds to the M/S→LR transition section, among stereo TD encoding frames illustrated in FIG. 13.

$$[ 5 ]$$

$$( \begin{matrix}{L}_{n} \\ {R}_{n}\end{matrix} ) = \frac{1}{1 + {α}_{n}^{2}} U ( \begin{matrix}{M}_{n} \\ {S}_{n}\end{matrix} ) , \qquad ( Equation 5 )$$

$$U = ( \begin{matrix}1 + {α}_{n} & - 1 + {α}_{n} \\ 1 - {α}_{n} & 1 + {α}_{n}\end{matrix} ) ,$$

$${α}_{n} = \frac{n}{N} , n = 0 , ⋯ , N - 1$$

By the inverse mixing processing expressed by Equation 5, the decoded stereo signal gradually transitions from an M/S signal to an LR signal over time n.

For example, channel conversion processing (inverse mixing processing) expressed by the following Equation 6 may be performed on the fourth frame from the left corresponding to the first frame that corresponds to the LR→M/S transition section, among stereo TD encoding frames illustrated in FIG. 13.

$$[ 6 ]$$

$$( \begin{matrix}{L}_{n} \\ {R}_{n}\end{matrix} ) = \frac{1}{1 - {α}_{n} + 0.5 {α}_{n}^{2}} U ( \begin{matrix}{M}_{n} \\ {S}_{n}\end{matrix} ) , \qquad ( Equation 6 )$$

$$U = ( \begin{matrix}1 - \frac{1}{2} {α}_{n} & - \frac{1}{2} {α}_{n} \\ \frac{1}{2} {α}_{n} & 1 - \frac{1}{2} {α}_{n}\end{matrix} ) ,$$

$${α}_{n} = \frac{n}{N} , n = 0 , ⋯ , N - 1$$

By the inverse mixing processing expressed by Equation 6, the decoded stereo signal gradually transitions from an LR signal to an M/S signal over time n.

As described above, performing transition of the coding modes and the inverse mixing processing makes it possible to seamlessly switch between CELP coding and MDCT coding and switch between M/S stereo and LR stereo in stereo TD encoding frames and stereo FD encoding frames.

The exemplary decoding system has been described above.

### Second Embodiment

Hereinafter, a second embodiment of the present disclosure will be described with reference to the drawings. The second embodiment is different from the first embodiment in that the second embodiment includes a means of determining whether at least some of main components of an input signal are present outside a core band of the CELP coding used for the stereo TD encoding is provided, and the result is used for control of switching coding modes.

In the first embodiment, as in PTL 1, a configuration is provided in which the encoding is switched to the stereo TD encoding using the CELP-based coding in a case where the following three conditions are satisfied in the stereo FD encoding.
1) It is determined that a full M/S coding mode is adopted (it is determined that using M/S encoding is more efficient than using LR encoding in all frequency bands).
2) A ratio of the number of bits required for encoding the Mid-channel to the number of bits required for encoding both the Mid-channel and the Side-channel is within a predetermined range.
3) It is determined that the input stereo signal is a speech signal (the input stereo signal strongly exhibits characteristics of a speech signal)

In speech/acoustic encoding, a bandwidth extension technology may be used for encoding high-frequency-band components in order to realize high quality sound at a low-bit rate. For example, Bandwidth Extension and Intelligent Gap Filling used in NPL 1 efficiently encode high-frequency-band components by using a model that generates a signal of a high-frequency band using components of a low-frequency band. In such bandwidth extension encoding, components of the low-frequency band are encoded by core encoding, and components of the high-frequency band are encoded by bandwidth extension encoding. In an example of the present disclosure, a frequency band for which components are encoded by core encoding is referred to as a “core band,” and a frequency band for which components are encoded by bandwidth extension encoding is referred to as an “extended band.”

However, in the bandwidth extension technique, high-frequency-band (extended band) components are not faithfully encoded, and thus encoding errors are likely to occur in the high-frequency-band components. In particular, in a case where a region in which the encoding error occurs is not a region of the LR stereo signal, but a region of the M/S stereo signal or a region during transition between both the regions, the encoding error may be expanded by the conversion processing to the LR stereo signal, resulting in an artifact that causes a problem in perception.

Therefore, in a case where the bandwidth extension encoding method is used in the M/S stereo coding scheme, it is necessary to take countermeasures for a case where main components of an input signal are included in a frequency band to which the bandwidth extension encoding is applied.

In the second embodiment, in a case where CELP-based coding using the bandwidth extension encoding is used for stereo TD encoding, the encoding apparatus determines whether the main components of the input signal are included in the extended band, and performs coding mode switching control to select stereo FD encoding without selecting stereo TD encoding in a case where the main components are included in the extended band.

### [Configuration Example 2 of Encoding System]

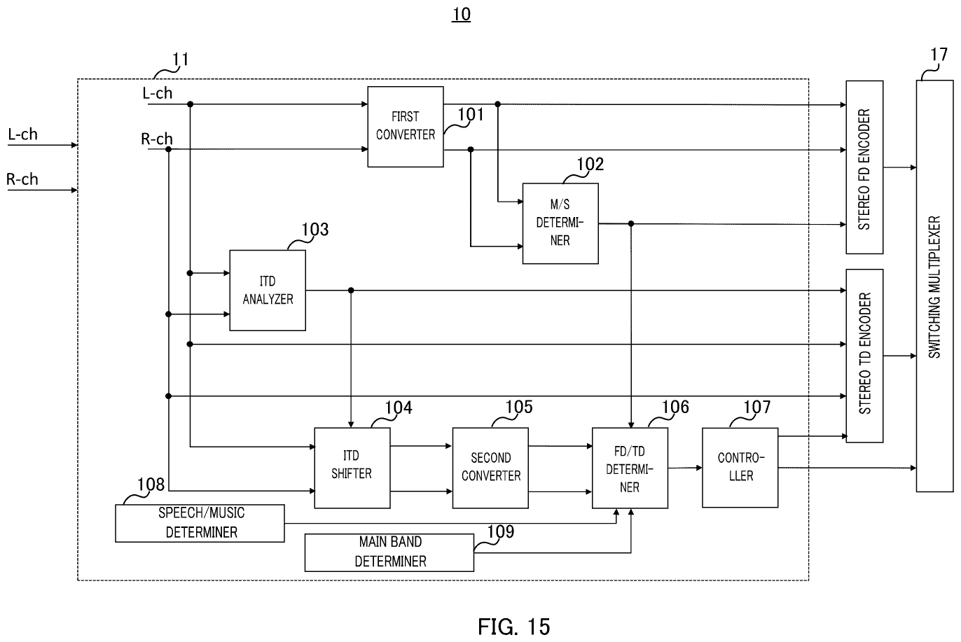

FIG. 15 is a diagram illustrating another configuration example of encoding apparatus 10 including conversion/analysis/preprocessing/encoding controller 11 further provided with main band determiner 109 that determines whether the main components of an input stereo signal are present in the extended band, with respect to the above-described configuration example of FIG. 3 described in the first embodiment. Since the configurations other than main band determiner 109 are in common with those in FIG. 3, the description thereof will be omitted. In FIG. 15, the input to main band determiner 109 is not shown, but a stereo signal including a left channel (L-channel) signal and a right channel (R-channel) signal may be inputted, or an analysis result outputted by an analyzer that inputs the stereo signal and performs some analysis may be inputted. In any case, main band determiner 109 outputs, to FD/TD determiner 106, information related to whether at least some of the main components of the input signal are present in the extended band (of the

CELP-based coding used for stereo TD encoding). FD/TD determiner 106 uses the information inputted from main band determiner 109 for determining the coding mode. Main band determiner 109 divides, for example, the frequency-converted (e.g., MDCT-converted) input signal into a plurality of bands, calculates the band energy each, calculates a ratio of a sum of the band energy included in the extended band to a sum of the band energies included in the core band and the extended band, and determines whether the main components of the input signal are present in the extended band according to whether the calculated ratio exceeds a predetermined threshold.

Another example of the internal configuration of conversion/analysis/preprocessing/encoding controller 11 has been described above.

### [Another Processing Example of Encoding Apparatus 10]

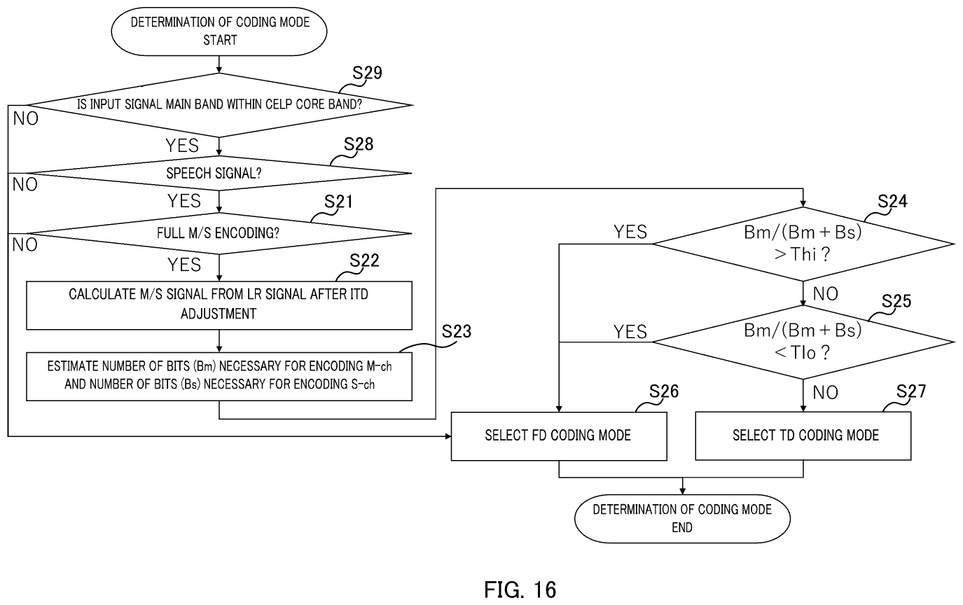

FIG. 16 is a processing flow in which a step (S29) of determining whether the main components of the input signal are present in the extended band is added to the determination procedure in FIG. 7 as a first processing step. Note that the order of the three determination steps (S21, S28, and S29) is not limited, but in the case of the stereo FD encoding as shown in PTL 1, the determination of whether the encoding is full M/S encoding is always performed, and thus performing step S21 first eliminates the need of unnecessarily performing steps S28 and S29.

In FIG. 16, in a case where the main components of the input signal are not present in the extended band (in a case where the main components of the input signal are within the core band of the CELP-based coding, S29: YES), FD/TD determiner 106 proceeds to the determination step (S28) of whether the input signal is a speech signal. On the other hand, in a case where the main components of the input signal are present in the extended band (in a case where the main components of the input signal are not within the core band of the CELP-based coding, S29: NO), FD/TD determiner 106 determines to select an FD coding mode (S26).

The step of determining whether the main components of the input signal are present in the extended band need not be performed at the beginning of the processing flow in FIG. 16. For example, the step may be performed after the determination step (S21) of whether the full M/S coding mode is adopted. The three determination steps (S21, S28, and S29) may be performed in any order, and may be determined by a logical product of three conditions (whether the coding mode is a full M/S coding mode, whether the signal is a speech signal, and whether the main components are present in the extended band). The determination of whether the main components of the input signal are present in the extended band is performed by, for example, main band determiner 109 in FIG. 15, and information on the determination result is inputted to FD/TD determiner 106.

As described above, in a case where the TD coding mode is determined to be applied, encoding apparatus 10 converts the LR stereo signal into the M/S stereo signal for the stereo speech signal, and encodes the Mid-signal and the Side-signal using the CELP-based encoder. Note that, in FIG. 15, a case has been described in which the determination of whether the value of Bm/(Bm+Bs) exceeds threshold Tlo (or whether the value is equal to or greater than Tlo) is performed, and then the determination of whether the value of Bm/(Bm+Bs) exceeds threshold Thi (or whether the value is equal to or less than Thi) is performed, but the determinations may be performed in the reverse order, or it may be determined whether the value of Bm/(Bm+Bs) is within a certain numerical range at once. In this way, by selecting the TD coding mode only in a case where the value of Bm/(Bm+Bs) is within a certain numerical range, the TD coding mode can be selected only when there is a definite advantage in performing the CELP coding, thereby enhancing the coding performance.

In order to avoid a situation in which the FD coding mode and the TD coding mode are frequently switched, a condition for switching may be that a mode to be switched to is selected in a certain number of past frames (by the above-described determination procedure).

For example, encoding apparatus 10 holds, as a counter, the number of frames until the mode is switched, decrements the counter by one when a mode different from the coding mode used in an immediately preceding frame is selected, increments the counter by one when the same mode as the mode used in the immediately preceding frame is selected, and switches modes when the counter becomes zero or less.

For example, in the present embodiment, since the FD coding mode is a basic coding mode, encoding apparatus 10 sets the counter to an initial value (e.g., 20), assuming that the FD coding mode is originally selected in the past. In a case where the determination result of the first frame is the TD coding mode, encoding apparatus 10 decrements the counter by one to set the counter to 19. In this case, the counter is not zero or less, and thus encoding apparatus 10 does not switch the coding mode even though the determination result indicates the TD coding mode, and performs encoding using the FD coding mode. Encoding apparatus 10 switches the coding mode to the TD coding mode in a frame in which the counter becomes zero or less as a result of continuous determination of the TD coding mode in subsequent frames. Encoding apparatus 10 resets the counter after switching to the TD coding mode. The reset value is the number of frames required for switching from the TD encoding to the FD encoding, and may be the same as the number of frames required for switching from the FD encoding to the TD encoding (20 in the above example), or may be smaller (e.g., 10) prioritizing the FD encoding.

In addition, the number of frames required for switching to the FD encoding may be changed depending on whether the TD encoding is likely to be selected in the subsequent frames. For example, in a case where the value of Bm/(Bm+Bs) when switching to the TD encoding is large (e.g., exceeds 0.8), encoding apparatus 10 may determine that the TD encoding is likely to be selected also in the subsequent frames, and reset the counter to be long (e.g., 20), otherwise (in a case where the value of Bm/(Bm+Bs) is small (e.g., less than 0.8) but the TD coding mode is selected), the counter may be reset to be short (e.g., 10).

In addition, in a case where the TD coding mode is selected and the value of Bm/(Bm+Bs) is large (e.g., equal to or greater than 0.8) in a frame in which the FD coding mode is used, the number to be subtracted from the counter may be two instead of one (or may be further increased) in order to reduce the number of frames required for switching to the TD coding mode. In this case, the number to be added to the counter when the same coding mode as the coding mode used in the immediately preceding frame is selected may remain one.

In this way, by changing the reset value of the counter or changing the number to be added to or subtracted from the counter, it is possible to control the ease of switching (difficulty of switching) to the TD coding mode or the ease of switching (difficulty of switching) to the FD coding mode.

The second embodiment has been described above.

As described above, in the present embodiment, for example, in a case where an input stereo signal is determined to be a signal suitable for encoding using a full M/S coding mode, encoding apparatus 10 determines whether to apply a stereo TD coding mode or a stereo FD coding mode based on a numerical value calculated by using the number of bits

(Bm) estimated to be necessary for encoding the Mid-channel and the number of bits (Bs) to be necessary for encoding the Side-channel. Then, in a case where the stereo TD coding mode is determined to be applied, encoding apparatus 10 converts the stereo signal into an M/S signal, and applies CELP coding to the signal (M signal) of the Mid-channel, and in a case where the stereo FD coding mode is determined to be applied, encoding apparatus 10 performs spectral coding on the stereo signal.

By way of example, in a case where the numerical value (e.g., Bm/(Bm+Bs)) calculated by using the number of bits (Bm) estimated to be necessary for encoding the Mid-channel and the number of bits (Bs) to be necessary for encoding the Side-channel is equal to or greater than a first threshold (e.g., Tlo) and equal to or less than a second threshold (e.g., Thi), encoding apparatus 10 may determine to apply the stereo TD coding mode (e.g., CELP-based coding). In addition, for example, in a case where the numerical value (e.g., Bm/(Bm+Bs)) is less than the first threshold (e.g., Tlo) or exceeds the second threshold (e.g., Thi), encoding apparatus 10 may determine to apply the stereo FD coding mode.

In this way, encoding apparatus 10 can determine whether the stereo signal is a stereo signal advantageous for the CELP-based coding, based on whether the ratio of the number of bits to be necessary for encoding the Mid-channel to the number of bits to be necessary for encoding the M/S stereo signal is within a predetermined range (e.g., 65% to 85%). In addition, for example, encoding apparatus 10 may determine whether the stereo signal is a stereo signal advantageous for the CELP-based coding in a case where the characteristics of a speech signal are seen in the stereo signal.

This allows encoding apparatus 10 to accurately determine a case where the coding performance for the speech signal can be improved by using the CELP-based coding rather than the MDCT-based coding method. Therefore, according to the present embodiment, encoding apparatus 10 can enhance the coding performance of the speech signal by using the CELP coding at a low-bit rate.

In addition, for example, encoding apparatus 10 adjusts an inter-channel time difference (ITD) between an L-channel and an R-channel in the input stereo signal to less than or equal to a threshold (e.g., in the vicinity of zero) in the stereo TD encoding, and performs encoding on the M/S signal after the ITD adjustment.

Accordingly, for example, ITD can be made close to zero in encoding of a speech signal using the M/S stereo scheme, which avoids ITD from affecting coding performance and enhances coding performance for stereo signals using CELP coding. Further, in the present embodiment, ITD adjustment processing is performed by encoding apparatus 10 but not performed by decoding apparatus 20. Thus, information on ITD adjustment need not be transmitted to decoding apparatus 20, which suppresses an increase in the amount of encoding information or the processing amount of decoding apparatus 20.

Note that, in the above-described embodiment, a case where a “full M/S coding mode” is selected has been described as a case where the input stereo signal is determined to be a signal suitable for encoding using only an M/S stereo scheme, but the present disclosure is not limited thereto.

For example, the determination of selecting the full M/S coding mode may be performed based on whether a percentage of bands determined to use the M/S stereo scheme among a plurality of bands (sub-bands) of the frequency spectrum of the input stereo signal is greater than or equal to a threshold. For example, when the percentage of bands determined to use the M/S stereo scheme is greater than or equal to the threshold, the full M/S coding mode may be selected.

Alternatively, for example, the determination of whether to select the full M/S coding mode may be performed based on whether the M/S stereo scheme is determined to be used in all of the plurality of bands of the frequency spectrum of the stereo signal converted into the frequency domain. For example, when the M/S stereo scheme is determined to be used in all of the bands, the full M/S coding mode may be selected.

Further, the parameters used in the above-described embodiment, such as the number of frames, the number of samples, the angle of resolution, and the thresholds, are merely examples, and may be other values.

The present disclosure can be realized by software, hardware, or software in cooperation with hardware. Each functional block used in the description of each embodiment described above can be partly or entirely realized by an LSI such as an integrated circuit, and each process described in each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI herein may be referred to as an IC, a system LSI, a super LSI, or an ultra LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. The communication apparatus may comprise a transceiver and processing/control circuitry. The transceiver may comprise and/or function as a receiver and a transmitter. The transceiver, as the transmitter and receiver, may include an RF (radio frequency) module and one or more antennas. The RF module may include an amplifier, an RF modulator/demodulator, or the like. Some non-limiting examples of such a communication apparatus include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT).”

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

An encoding apparatus according to an embodiment of the present disclosure includes: a controller, which in operation, determines, in a case where an inputted stereo signal is determined to be a signal suitable for encoding using a mid-side stereo scheme, whether to apply a first coding mode or a second coding mode, based on a numerical value calculated by using a number of bits estimated to be necessary for encoding a mid-channel and a number of bits estimated to be necessary for encoding a side-channel; a first encoder, which in operation, applies Code-Excited-Linear-Prediction (CELP) coding to a signal of the mid-channel in a case where the first coding mode is determined to be applied; and a second encoder, which in operation, performs spectral coding on the stereo signal in a case where the second coding mode is determined to be applied.

In the embodiment of the present disclosure, the controller determines to apply the first coding mode in a case where the numerical value is equal to or greater than a first threshold and equal to or less than a second threshold, and the controller determines to apply the second coding mode in a case where the numerical value is less than the first threshold or greater than the second threshold.

In the embodiment of the present disclosure, the first coding mode is multi-mode coding including the CELP coding.

In the embodiment of the present disclosure, the controller determines whether the stereo signal is a speech signal, and the controller determines to apply the first coding mode in a case where the stereo signal is determined to be a speech signal and the numerical value is equal to or greater than a first threshold and equal to or less than a second threshold.

In the embodiment of the present disclosure, the case where the inputted stereo signal is determined to be the signal suitable for encoding using the mid-side stereo scheme is a case where the mid-side stereo scheme is determined to be used in all of a plurality of bands of a frequency spectrum of the stereo signal converted into a frequency domain.

In the embodiment of the present disclosure, the encoding apparatus further includes an adjuster, which in operation, performs adjustment processing of bringing an inter-channel time difference between a left channel and a right channel of the inputted stereo signal close to zero, in which the first encoder performs the CELP coding on the signal of the mid-channel obtained by converting the stereo signal after the inter-channel time difference is adjusted.

In the embodiment of the present disclosure, a range of the adjustment of the inter-channel time difference is based on angular resolution for reproducing a speech signal.

In the embodiment of the present disclosure, the controller performs Modified Discrete Cosine Transform (MDCT)-based coding of the first coding mode in a section adjacent to a section in which the second coding mode is applied, among a plurality of consecutive sections to which the first coding mode is applied.

In an encoding method according to an embodiment of the present disclosure, an encoding apparatus determines, in a case where an inputted stereo signal is determined to be a signal suitable for encoding using a mid-side stereo scheme, whether to apply a first coding mode or a second coding mode, based on a numerical value calculated by using a number of bits estimated to be necessary for encoding a mid-channel and a number of bits estimated to be necessary for encoding a side-channel, applies Code-Excited-Linear-Prediction (CELP) coding to a signal of the mid-channel in a case where the first coding mode is determined to be applied, and performs spectral coding on the stereo signal in a case where the second coding mode is determined to be applied.

The disclosures of Japanese Patent Application No. 2023-017778, filed on Feb. 8, 2023 and Japanese Patent Application No. 2023-064797, filed on Apr. 12, 2023, each including the specification, drawings and abstract, are incorporated herein by reference in their entirety.

### INDUSTRIAL APPLICABILITY

An exemplary embodiment of the present disclosure is useful for encoding systems and/or the like.

### REFERENCE SIGNS LIST

10 Encoding apparatus
11 Conversion/analysis/preprocessing/encoding controller
12 M/S converter
13 Spectral encoder
14 ITD adjuster
15 Mixer
16 CELP-based encoder
17 Switching multiplexer
20 Decoding apparatus
21 Separation switcher
22 Spectral decoder
23 Inverse M/S converter
24 Inverse converter
25 CELP-based decoder
26 Inverse mixer
27 Switcher
101 First converter
102 M/S determiner
103 ITD analyzer
104 ITD shifter
105 Second converter
106 FD/TD determiner
107 Controller
108 Speech/music determiner
109 Main band determiner

1. An encoding apparatus comprising:
a controller, which in operation, determines, in a case where an inputted stereo signal is determined to be a signal suitable for encoding using a mid-side stereo scheme, whether to apply a first coding mode or a second coding mode, based on a numerical value calculated by using a number of bits estimated to be necessary for encoding a mid-channel and a number of bits estimated to be necessary for encoding a side-channel;
a first encoder, which in operation, applies Code-Excited-Linear-Prediction (CELP) coding to a signal of the mid-channel in a case where the first coding mode is determined to be applied; and
a second encoder, which in operation, performs spectral coding on the stereo signal in a case where the second coding mode is determined to be applied.

2. The encoding apparatus according to claim 1, wherein
the controller determines to apply the first coding mode in a case where the numerical value is equal to or greater than a first threshold and equal to or less than a second threshold, and
the controller determines to apply the second coding mode in a case where the numerical value is less than the first threshold or greater than the second threshold.

3. The encoding apparatus according to claim 2, wherein
the first coding mode is multi-mode coding including the CELP coding.

4. The encoding apparatus according to claim 1, wherein
the controller determines whether the stereo signal is a speech signal, and
the controller determines to apply the first coding mode in a case where the stereo signal is determined to be the speech signal and the numerical value is equal to or greater than a first threshold and equal to or less than a second threshold.

5. The encoding apparatus according to claim 1, wherein
the case where the inputted stereo signal is determined to be the signal suitable for encoding using the mid-side stereo scheme is a case where the mid-side stereo scheme is determined to be used in all of a plurality of bands of a frequency spectrum of the stereo signal converted into a frequency domain.

6. The encoding apparatus according to claim 1, further comprising an adjuster, which in operation, performs adjustment processing of bringing an inter-channel time difference between a left channel and a right channel of the inputted stereo signal close to zero, wherein
the first encoder performs the CELP coding on the signal of the mid-channel obtained by converting the stereo signal after the inter-channel time difference is adjusted.

7. The encoding apparatus according to claim 6, wherein
a range of the adjustment of the inter-channel time difference is based on angular resolution for reproducing a speech signal.

8. The encoding apparatus according to claim 6, wherein
the controller performs Modified Discrete Cosine Transform (MDCT)-based coding of the first coding mode in a section adjacent to a section in which the second coding mode is applied, among a plurality of consecutive sections to which the first coding mode is applied.

9. An encoding method comprising:
determining, by an encoding apparatus, in a case where an inputted stereo signal is determined to be a signal suitable for encoding using a mid-side stereo scheme, whether to apply a first coding mode or a second coding mode, based on a numerical value calculated by using a number of bits estimated to be necessary for encoding a mid-channel and a number of bits estimated to be necessary for encoding a side-channel;
applying, by the encoding apparatus, Code-Excited-Linear-Prediction (CELP) coding to a signal of the mid-channel in a case where the first coding mode is determined to be applied; and
performing, by the encoding apparatus, spectral coding on the stereo signal in a case where the second coding mode is determined to be applied.
